(19) United States
(12) Patent Application Publication
(10) Pub. No.: US 2015/0314691 A1
(43) Pub. Date: Nov. 5, 2015

(54) LIGHT ELECTRIC VEHICLE WITH POWER BUS

(71) Applicant: Control Point Corporation, Goleta, CA (US)

(72) Inventors: Jonathan Dorny, Goleta, CA (US); Paul Donohoe, Santa Barbara, CA (US); Anthony Taormina, Santa Barbara, CA (US)

(73) Assignee: Control Point Corporation, Goleta, CA (US)

(21) Appl. No.: 13/713,411

(22) Filed: Dec. 13, 2012

(51) Int. Cl. B60L 11/18

(52) U.S. Cl. CPC B60L 11/1805

(57) ABSTRACT

The present invention provides power for electronic devices in connection with a light electric vehicle. A power system is connected the high voltage battery pack of the light electric vehicle. The power system includes a converter for providing voltage levels less than that of the battery pack, preferably at the 5 volt and 12 volt levels. The power system includes one or more outlets for accessing the different power levels. The power system includes a light control for high efficiency operation of vehicle lights and integration with controls on the light electric vehicle.

### BACKGROUND OF THE INVENTION

1. Field of the Invention

The present invention relates to operation of electronic devices in association with or connected to a light electric vehicle. More particularly, it relates to provision of a power bus of an appropriate voltage from the batteries of the light electric vehicle for operation of additional electronic devices.

2. Discussion of Related Art

The market for electric bicycles and other light electric vehicles has been growing. An electric bicycle, or e-bike, is a bicycle with an electric motor used to power the vehicle in addition to the pedals. Electric bicycles use rechargeable batteries and can typically travel up to 15 to 20 miles per hour. The motor makes operation of the bicycle easier for the user, particularly on hills. The energy costs of operating electric bicycles are small. Riding an electric bicycle to work or to the store instead of taking a car has long term financial, energy conservation and health gains.

Light electric vehicles (“LEV”) are an extension of electric bicycles to include vehicles having additional features and capabilities. LEVs may have more than two wheels. They may have additional cargo or passenger carrying capacity. Often, they do not include pedals and run only using the motor. Light electric vehicles have regulated speed restrictions which enable them to be safe in environments where automobiles are not permitted. Light electric vehicles have advantages over automobiles in that they are more maneuverable and can travel off roads more easily. In many situations, light electric vehicles are more energy efficient than automobiles and are significantly less expensive to acquire. Thus, light electric vehicles are being used for travel within large facilities, such as military bases, colleges, housing developments, and corporate campuses. They can provide an efficient means of transportation for security, emergency and maintenance personnel around these facilities. Light electric vehicles also enable a high level of social interaction and maneuverability within neighborhoods, event facilities, campus locations, or pedestrian crowded environments.

The range and functionality of light electric vehicles are limited by their power consumption. In order to maintain their low cost, limited weight and high level of maneuverability, the sizes of the motor and batteries must be restricted. This limits speed and range. When the motor or batteries are increased, the efficiency of the vehicle drops. This further limits their ability to carry additional passengers and cargo.

Often, multiple electric devices are used in connection with a light electric vehicle. Such devices may include communication and computing devices, such as smart phones and tablets, lighting, and audio devices, such as two-way radios. However, in order to provide sufficient power for operation of the light electric vehicle, the battery packs on such vehicles use much higher voltages, 18 volts to 72 volts, than are typically used with associated electronic devices. As currently known, the battery packs for light electric vehicles cannot directly provide power to other electronic devices.

### SUMMARY OF THE INVENTION

The present invention provides a power system for electronic devices in connection with the light electric vehicle. According to one aspect of the invention, the power system includes a converter attached to the batteries of the light electric vehicle. The converter provides output voltages necessary for different types of electronic devices. According to another aspect of the invention, the converter is controllable so that voltages are provided only as needed. According to another aspect of the invention, the power system includes one or more power buses having one or more power connections for electronic devices. According to another aspect of the invention, the power system provides power for operation of lights on the light electric vehicle. According to another aspect of the invention, the lights are illuminated based upon operation of the light electric vehicle. According to another aspect of the invention, the power system provides power for operation of a communication system associated with the vehicle.

### BRIEF DESCRIPTION OF THE DRAWINGS

FIG. 1 is a block diagram of a light electric vehicle having a power system according to an embodiment of the present invention.

### DETAILED DESCRIPTION

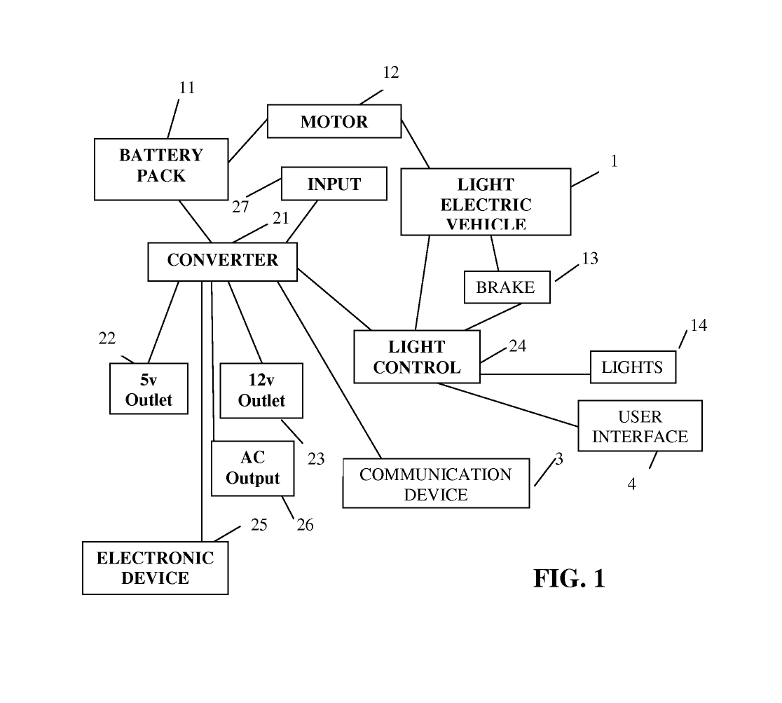

FIG. 1 illustrates a light electric vehicle. As is known, the light electric vehicle 1 includes a motor 12 and a battery pack 11. The battery pack 11 provides power for operation of the motor to move the light electric vehicle 1. As is known, the battery pack 11 has a voltage typically between 24 volts and approximately 72 volts. The higher voltages allow for more efficient use of power by the light electric vehicle 1. The light electric vehicle 1 also includes a braking system 13 for stopping the vehicle and may include lights 14.

An embodiment of a power system according to the present invention, illustrated in FIG. 1, provides power from the battery pack 11 for operating additional electronic devices associated with the light electric vehicle 1. The power system includes a converter 21 connected to the battery pack 11. The converter 21 operates to provide one or more voltage levels lower than that of the battery pack 11. The converter 21 may be selectively operable so that the voltage levels are only provided when desired by the operator of the vehicle.

According to an embodiment of the invention, the converter 21 provides voltage levels at 5 volts and 12 volts. These voltages are commonly utilized by electronic devices which may be associated with the light electric vehicle. One or more outlets are provided for the 5 volt (22) and 12 volt (23) power levels. The 12 volt outlet may include a “cigarette lighter” type output or a connector for audio devices or a two-way radio. The 5 volt outlet preferably includes a USB port for powering or charging mobile electronics.

According to an embodiment of the invention, the power system includes a lighting control 24 for selectively operating the lights 14 on the light electric vehicle 1. The light control 24 allows operation of headlights (high output/low power, high & low-beam), Tail-lights, turn-signals, brake-lights, utility lighting, ‘vanity’ or accent lighting, and emergency response “flasher” lights. For efficient operation, the light control 24 provides high efficiency operation, such as solid state light driver and flasher modules. Preferably, the lights 14 also use high efficiency LED lights in order to minimize power loss from use of lighting.

The light control 24 is connected to the controls of the light electric vehicle for integrated operation of the lights. A user input 4 is connected to the light control 24 to allow the operator to turn the lights on and off. The user input 4 may be of any type of input. In particular, existing controls on the light electric vehicle 1 can function as the user input to activate the necessary lights. For example, the light control 24 can be connected to the braking system 13 so that the brake lights are automatically operated in connection with braking.

In addition to lights, the light control 24, or a separate similar control, could be used to control other equipment associated with the light electric vehicle 1. For example, an audio device could provide a siren in connection with the flasher lights. A siren or other audio device may be operable separately from the light control.

According to another embodiment of the invention, the converter 21 provides power for other electronic devices connected to or associated with the light electric vehicle 1. As illustrated in FIG. 1, the light electric vehicle 1 includes a communication device 3. The communication device may be used for communicating with other vehicles and/or with a central station to control fleet operations. The communication device 3, or other types of devices, is connected to the converter 21 to receive an appropriate power level for operation of the device.

The present invention is not limited as to the number or types of electronic devices which can be powered by the converter 21. The converter 21 can provide appropriate power to any type of electronic device 25 to be used with the light electric vehicle 1. Devices can be connected to a power outlet 22, 23 or wired to the converter 21. Such devices may include ones used in operating the vehicle, such a GPS or navigation system. Such devices may be used by the operator of the vehicle, such as a phone, tablet, radio, mp3 player, video player, etc. Such devices may also include a computer or telematics system controlling and/or monitoring operation of the vehicle. The converter 21 can also provide power to tools used by the operator to perform a function when not operating the vehicle. For example, the converter 21 can power devices for monitoring blood pressure or providing defibrillation in connection with a vehicle used to provide medical assistance.

According to another embodiment of the invention, the converter 21 can provide an AC output 26. An inverter (not shown) could be used to provide the AC output 26. The AC output allows the battery of the vehicle to be used to power many other devices used in emergency response situations. The AC output could include a standard 110 volt power outlet into which equipment can be plugged.

According to another embodiment of the invention, the system includes an input 27 for charging the battery pack 11 of the vehicle. The input 27 may be connected to the same converter 21 used to provide power from the battery pack 11, as shown, or may be connected another system which allows for battery charging. The input 27 may include multiple inputs. The input 27 also allows different types of voltages to be applied to charge the battery pack 11. For example, the input 27 may receive a 5 volt DC input from a solar panel or similar power source. The input 27 may also receive a 12 volt (or other voltage level) DC input from another battery, such as a truck battery, or from a charging system of a vehicle having a combustion engine. This would allow the battery pack 11 to be charged when the vehicle is being transported by a truck or other conventional vehicle. The converter 21 will change the input to the necessary voltage to charge the battery pack 11. The input 27 could also allow the converter 21 to be connected to another “stand-by” battery pack, either carried on the LEV or provided separately, to provide power to the LEV or to the other outputs 22, 23, 26 or electronic devices 24, 25 connected to the converter 21.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A power system for a light electric vehicle, the light electric vehicle including at least one battery having a first voltage level, the power system comprising:
a converter connected to the at least one battery for providing at least second voltage level different from the first voltage level; and
a power bus providing at least one output of the at least one second voltage.

2. The power system for a light electric vehicle according to claim 1, wherein the converter provides at least two second voltage levels.

3. The power system for a light electric vehicle according to claim 2, wherein the at least two second voltage levels includes 5 volts and 12 volts.

4. The power system for a light electric vehicle according to claim 1, further comprising at least one outlet connected to the at least one output of the power bus for selectively attaching an electronic device to the at least one output of the power bus.

5. The power system for a light electric vehicle according to claim 1, at least one electronic device connected to the at least one output of the power bus.

6. The power system for a light electric vehicle according to claim 5, wherein the at least one electronic device includes a communication device.

7. The power system for a light electric vehicle according to claim 5, wherein the at least one electronic device includes an audio controller.

8. The power system for a light electric vehicle according to claim 5, wherein the at least one electronic device includes a light controller.

9. The power system for a light electric vehicle according to claim 8, further comprising at least one light attached to the light electric vehicle connected to the light controller.

10. The power system for a light electric vehicle according to claim 9, further comprising at least one control attached to the light electric vehicle operable by the operator of the vehicle, the at least one control being connected to the light controller for controlling operation of the at least one light.

11. The power system for a light electric vehicle according to claim 5, wherein the at least one electronic device includes an inverter to provide AC power.

12. The power system for a light electric vehicle according to claim 11, wherein the AC power is provided at 110 volts.

13. The power system for a light electric vehicle according to claim 5, wherein the at least one electronic device includes a vehicle computer.

14. The power system for a light electric vehicle according to claim 5, wherein the at least one electronic device includes a telematics system.

15. The power system for a light electric vehicle according to claim 1, further comprising an input for charging the at least one battery.

16. The power system for a light electric vehicle according to claim 15, wherein the input includes a converter for changing a third voltage level to a voltage level to charge the at least one battery.

17. The power system for a light electric vehicle according to claim 15 wherein the third voltage level is 5 volts.

18. The power system for a light electric vehicle according to claim 15, wherein the third voltage level is 12 volt.
